(19) United States
(12) Patent Application Publication
(10) Pub. No.: US 2022/0031549 A1
(43) Pub. Date: Feb. 3, 2022

(54) DEVICE FOR PERFORMING VIBRATION TRAINING HAVING ADJUSTABLE HANDLES

(71) Applicant: Svetozar GRBIC, München (DE)

(72) Inventor: Svetozar GRBIC, München (DE)

(21) Appl. No.: 17/280,334

(22) PCT Filed: Sep. 30, 2019
(86) PCT No.: PCT/EP2019/076478

§ 371 Date: Mar. 26, 2021

(30) Foreign Application Priority Data
Sep. 28, 2018 (DE) 20 2018 105 586.0

(51) Int. Cl. A61H 1/00; A61H 23/02

(52) U.S. Cl. CPC A61H 1/005; A61H 2201/0192; A61H 2201/1635; A61H 23/02

(57) ABSTRACT

The invention relates to a device for carrying out vibration exercise by way of a device user, comprising a platform, two handles which are connected directly or indirectly to the platform and make support of the device user by means of his/her hands possible, and an actuator which is set up to set the platform and the handles which are connected to the platform in a vibration movement, it being possible for the spacing between the two handles to be varied.

The invention relates to a device for carrying out vibration exercise by way of a device user, comprising a platform, two handles which are connected directly or indirectly to the platform and make support of the device user by means of his/her hands possible, and an actuator which is set up to set the platform and the handles which are connected to the platform in a vibration movement, characterized in that the spacing between the two handles can be varied.

Devices for carrying out vibration exercise are used, for example, in fitness training, in rehabilitation or in physiotherapy for strengthening muscles and for increasing balance and coordination.

In the case of statutory devices, vibration movements of a platform are transmitted to a device user, the vibrations triggering muscular reflexes. Muscular contractions occur by way of the muscular reflexes. These muscle stresses ultimately lead to targeted and intensive training.

In addition to conventional devices for carrying out vibration exercise which have a platform which can be set in a vibration movement, further-reaching solutions are also known from the prior art.

DE20312552 U1 describes a massage device with a platform which is moved in an oscillating manner by a drive, with a rest for the human body and a grab handle which, however, is not connected to the platform and is therefore not set in a vibration movement.

U.S. Pat. No. 3,140,711 A describes a therapeutic training device with a vibrating platform, on which a person stands. In addition, the training device comprises two grab handles which, however, are not connected to the platform and are therefore not set in a vibration movement.

U.S. Pat. No. 7,402,145 B1 describes a massage device with a platform which is moved in an oscillating manner by a drive. A chair with lateral handles can be attached to said platform, and can therefore be set in a vibration movement together with the handles. The handles are height-adjustable, without it being possible for the spacing between the handles to be varied.

DE 20 2017 004 115 U1 describes a vibration device with a main body and a pad or housing part which is arranged above the main body and can be set vibrating by means of a drive mechanism. The pad or housing part is configured in such a way that handles can be attached to the upper pad or housing part in provided openings, which handles can be gripped by the user of the training device for training purposes.

DE 20 2016 104 715 U1 describes a vibration plate for training a user comprising a housing, an electrically operable actuator unit which is received in the housing, a surface which is arranged on the housing and can be used directly by way of a user for training while standing up, sitting and/or lying, a plurality of feet, and a plurality of receptacles which are arranged on the housing and/or on the surface for manually releasable fastening of a separate seat, the receptacles comprising round cut-outs which are provided in the housing for receiving feet of the seat. The seat comprises two supporting tubes, to which handles are attached by means of a welded seam.

It has been shown that, in the case of some exercises, supporting or holding firmly by way of both hands on the vibration platform is necessary while carrying out the vibration exercise; for example, in the case of push-ups. Direct supporting on the vibration platform has the disadvantage that their hands are angled away to a pronounced extent and, as a result, the ligaments and tendons in the wrists are loaded to a pronounced extent. The loading of the ligaments and tendons is intensified further by way of the vibration of the vibration platform.

It was an object of the present invention to provide a device for carrying out vibration exercise by way of a device user, which device makes training which is gentle on wrists possible, for example in the case of push-ups. Here, in addition, the device should be configured in such a way that it can also be adapted to the physical attributes of the device user.

According to the invention, this object is achieved by way of the subject matter of claim 1. Advantageous refinements of the invention are specified in the dependent claims.

According to the invention, a device (10) according to the invention for carrying out vibration exercise by way of a device user comprises:
a main body (G) of rigid configuration and a platform (11) which is configured such that it can be moved with regard to the main body (G),
two handles (12a, 12b) which are connected directly or indirectly to the platform (11) and make support of the device user by means of his/her hands possible,
an electrically operable actuator which is set up to set the platform (11) and the handles (12a, 12b) which are connected to the platform in a vibration movement (V), the platform (11) being connected via the actuator to the main body (G), it being possible for the horizontal spacing (A) between the two handles (12a, 12b) to be varied.

It has been shown that the loading on the wrists during the training and, in particular, during the performance of push-ups can be reduced by way of the use of handles which make it possible for the device user to support himself/herself by means of his/her hands. Since the horizontal spacing between the two handles can be varied, the handle position can additionally be adapted to the physical attributes of the device user. Both device users with wide shoulders and therefore with a great spacing between the shoulder joints and device users with narrow shoulders and a small spacing between the shoulder joints can select the spacing between the handles in such a way that optimum training which is gentle on the joints can be carried out.

A device (10) according to the invention for carrying out vibration exercise is preferred, it being possible for the horizontal spacing between the two handles (12a, 12b) to be varied in an infinitely variable manner, preferably within a predefined range.

Our own tests have shown that it is advantageous if the spacing between the two handles (12a, 12b) can be varied in an infinitely variable manner. The spacing can be adapted in the process in an even more improved manner to the requirements of the user, by it being possible for the spacing to be set to the spacing which is ideal for the respective user.

A device (10) according to the invention for carrying out vibration exercise is preferred, the handles (12a, 12b) being connected to the platform (11) via a supporting structure (13).

It has been shown in our own tests that it is particularly advantageous if the handles are connected via a supporting structure to the platform. As a result, for example, it is possible for the two handles including the supporting structure to be removed from the movably configured platform (11) during training and to be placed to the side.

A device (10) according to the invention for carrying out vibration exercise is preferred, the supporting structure (13) comprising two U-shaped supporting tubes (14a, 14b) with in each case one straight tube section (14a′, 14b′) and two end sections (14a″, 14b″) which are bent away in each case from the straight tube section (14a′, 14b′), the end sections (14a″, 14b″) preferably being connected in each case to the platform (11).

A device (10) according to the invention for carrying out vibration exercise is preferred, the U-shaped supporting tubes (14a, 14b) being connected to one another by way of one, two, three or more than three transverse connections, the transverse connections preferably being tubes which extend substantially orthogonally with respect to the straight tube sections (14a′, 14b′) of the supporting tubes (14a, 14b).

Our own tests have shown that transverse connections contribute to a higher stability of the device according to the invention and/or to a higher stability of the U-shaped supporting tubes, and therefore make the training safer and more comfortable for the user.

A device (10) according to the invention for carrying out vibration exercise is preferred, the handles (12a, 12b) being arranged on the straight tube sections (14a′, 14b′) and it being possible for them to be displaced along the straight tube sections (14a′, 14b′).

A device (10) according to the invention for carrying out vibration exercise is preferred, the handles (12a, 12b) extending substantially orthogonally with respect to the straight tube sections (14a′, 14b′) of the supporting tubes (14a, 14b).

It has been shown in our own tests that it is particularly advantageous, in particular during vibration exercise, if the handles run substantially orthogonally with respect to the straight tube sections of the supporting tubes, and are therefore parallel to one another. As a result, in particular, the joints of the user are relieved during training with the handles.

A device (10) according to the invention for carrying out vibration exercise is preferred, a seat (15) being arranged on the supporting structure (13).

A device (10) according to the invention for carrying out vibration exercise is preferred, the seat (15) being arranged on the straight tube sections (14a) of the supporting tubes.

A device (10) according to the invention for carrying out vibration exercise is preferred, the seat (15) being arranged between the handles (12a, 12b).

As a result of the arrangement of the seat between the handles, it is possible that the user can grip the handles firmly during seated training.

A device (10) according to the invention for carrying out vibration exercise is preferred, the seat (15) having a substantially identical or greater horizontal extent to/than the platform (11).

A device (10) according to the invention for carrying out vibration exercise is preferred, with a control unit which is set up to control the first actuator. The control unit is preferably a remote control which communicates via radio waves with the device and makes regulating of the device possible. It is particularly preferred here if individual programs, the intensity or a time of the device can be set. The control unit can also be integrated into the device (10), however, or the device (10) has two control units, for example a unit which is integrated into the device (10) and an additional radio control unit.

A device (10) according to the invention for carrying out vibration exercise is preferred, the control unit being set up to vary the intensity, the speed and/or the extent of the vibration movement (V).

A device (10) according to the invention for carrying out vibration exercise is preferred, the platform (11) having a stepping area (16) which is set up to be stepped on by a device user.

A device (10) according to the invention for carrying out vibration exercise is preferred, with a plurality of feet (40a-40d) which are connected to the main body (G), it being possible for the height of one, a plurality or all of the feet (40a-40d) to be set.

A device (10) according to the invention for carrying out vibration exercise is preferred, the supporting structure (13) being connected releasably to the platform (11).

A device (10) according to the invention for carrying out vibration exercise is preferred, the platform comprising a plurality of, preferably four, receptacles for releasable fastening of the supporting structure (13), via which receptacles the supporting structure can be connected releasably to the platform (11).

The actuator can have a battery and/or a power supply unit. The power supply unit can be connected to a current supply. The housing, the main body (G) and/or the platform can be formed from hard plastic.

According to the invention, a device (10) for carrying out vibration exercise by way of a device user is preferred, comprising
a main body (G) of rigid configuration and a platform (11) which is configured such that it can be moved with regard to the main body (G),
two handles (12a, 12b) which are connected directly or indirectly to the platform (11) and make support of the device user by means of his/her hands possible, the handles (12a, 12b) being connected via a supporting structure (13) to the platform (11), and the supporting structure (13) comprising two U-shaped supporting tubes (14a, 14b) with in each case one straight tube section (14a′, 14b′) and two end sections (14a″, 14b″) which are bent away in each case from the straight tube section (14a′, 14b′), the end sections (14a″, 14b″) preferably being connected in each case to the platform (11),
an electrically operable actuator which is set up to set the platform (11) and the handles (12a, 12b) which are connected to the platform in a vibration movement (V), the platform (11) being connected via the actuator to the main body (G),

the handles (12a, 12b) being arranged on the straight tube sections (14a′, 14b′) and it being possible for them to be displaced along the straight tube sections (14a′, 14b′), in order for it to be possible for the horizontal spacing (A) between the two handles (12a, 12b) to be varied in an infinitely variable manner within a predefined range,

a seat (15) being arranged on the supporting structure (13), and the seat (15) being arranged on the straight tube sections (14a) of the supporting tubes between the handles (12a, 12b),

and the supporting structure (13) being connected in a positively locking and releasable manner to the platform (11).

Within the context of the present invention, a releasable connection is understood to mean a connection which makes destruction-free releasing of different parts possible. For example, adhesive bonding or welding are to be distinguished from a releasable connection. In the present case, pure positioning on top or placing on top, in the case of which the connection takes place merely via a non-positive connection and/or by way of the static friction, is also not to be understood as a releasable connection.

According to the invention, the handles (12a, 12b) are connected directly or indirectly to the platform (11). A direct connection of the handles (12a, 12b) to the platform (11) is understood to mean a connection, in the case of which the handles and the platform are directly in contact, without further components being arranged between the handles and the platform. An indirect connection of the handles (12a, 12b) to the platform (11) is understood to mean a connection, in the case of which the handles (12a, 12b) and the platform are not directly in contact, but rather are connected to the platform (11) via further components, for example via a supporting structure (13). According to the invention, it is particularly preferred if the handles (12a, 12b) are connected via a supporting structure (13) to the platform (11), and the supporting structure (13) comprises two U-shaped supporting tubes (14a, 14b) with in each case one straight tube section (14a′, 14b′) and two end sections (14a″, 14b″) which are bent away in each case from the straight tube section (14a′, 14b′), the handles (12a, 12b) being arranged on the straight tube sections (14a′, 14b′). Both in the case of the direct connection and in the case of the indirect connection of the handles to the platform (11), the handles are connected in a positively locking manner to the platform (11). Pure positioning or placing of the handles on top of the platform is to be distinguished herefrom.

A further aspect of the present invention relates to the use of a supporting structure (13) for training on a device for carrying out vibration exercise, the supporting structure having two U-shaped supporting tubes (14a, 14b) with in each case one straight tube section (14a′, 14b′) and two end sections (14a″, 14b″) which are bent away in each case from the straight tube section (14a′, 14b′), two handles (12a, 12b) being arranged on the straight tube sections (14a′, 14b′), and it being possible for them to be displaced along the straight tube sections (14a′, 14b′).

Further refinements of the supporting structure are described further above for a device (10) according to the invention for carrying out vibration exercise.

In the following text, preferred embodiments of the invention will be explained and described in greater detail with reference to the appended drawings, in which:

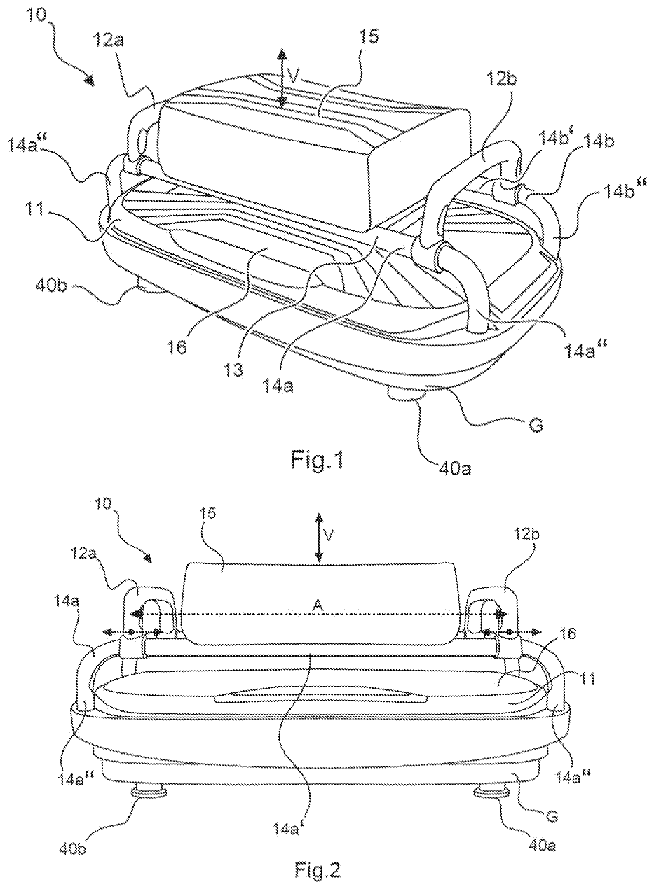

FIG. 1 shows an exemplary embodiment of the device according to the invention for carrying out vibration exercise in a diagrammatic illustration, and

FIG. 2 shows the device for carrying out vibration exercise from FIG. 1 from a further perspective.

FIG. 1 shows a device (10) for carrying out vibration exercise by way of a device user (not depicted). The device consists of a main body (G) which is of rigid configuration and is set down on the floor via four feet (40a-d, not all visible in this perspective). In addition, the device has a platform (11) which is configured such that it can be moved with regard to the main body (G). In addition, the device comprises two handles (12a, 12b) which are connected to the platform (11) indirectly (via a supporting structure (13)) and make support of the device user by means of his/her hands possible, the handles (12a, 12b) being connected via a supporting structure (13) to the platform (11), and the supporting structure (13) comprising two U-shaped supporting tubes (14a, 14b) with in each case one straight tube section (14a′, 14b′) and two end sections (14a″, 14b″) which are bent away in each case from the straight tube section (14a′, 14b′). In the present case, the end sections (14a″, 14b″) are connected in a positively locking and releasable manner in each case to the platform (11), by it being possible for the end sections to be introduced partially into corresponding receptacles in the platform (11). The device comprises an electrically operable actuator (not depicted) which is set up to set the platform (11) and the handles (12a, 12b) which are connected to the platform in a vibration movement (V), the platform (11) being connected via the actuator to the main body (G). The handles (12a, 12b) are arranged on the straight tube sections (14a′, 14b′), and can be displaced along the straight tube sections (14a′, 14b′), in order to vary the horizontal spacing (A) between the two handles (12a, 12b) in an infinitely variable manner within a predefined range. In addition, a seat (15) is arranged on the straight tube sections (14a) of the supporting tubes of the supporting structure (13) and between the handles (12a, 12b). The platform (11) is covered with a stepping area (16) which is made from rubber, is adhesively bonded to the platform in the present case, and ensures secure footing of the device user.

FIG. 2 shows the device for carrying out vibration exercise from FIG. 1 from a further perspective. In this figure, in particular, the direction of movement of the handles during the infinitely variable displacement of the handles is indicated by way of two double arrows.

### LIST OF REFERENCE SIGNS

10 Device
11 Platform
12a, 12b Handle
13 Supporting structure
14a, 14b Supporting tube
14a′ Straight tube section of the supporting tube 14a
14b′ Straight tube section of the supporting tube 14b
14a″ Bent-away end section of the supporting tube 14a
14b″ Bent-away end section of the supporting tube 14b
15 Seat
16 Stepping area
V Vibration movement
G Main body
40a-40d Feet
A Spacing between the handles 12a and 12b

1. A device (10) for carrying out vibration exercise by way of a device user, comprising
a main body (G) of rigid configuration and a platform (11) which is configured such that it can be moved with regard to the main body (G),
two handles (12a, 12b) which are connected directly or indirectly to the platform (11) and make support of the device user by means of his/her hands possible,
an electrically operable actuator which is set up to set the platform (11) and the handles (12a, 12b) which are connected to the platform in a vibration movement (V), the platform (11) being connected via the actuator to the main body (G),
characterized in that the horizontal spacing (A) between the two handles (12a, 12b) can be varied.

2. The device according to claim 1, characterized in that the horizontal spacing between the two handles (12a, 12b) can be varied in an infinitely variable manner, preferably within a predefined range.

3. The device (10) according to claim 1, characterized in that the handles (12a, 12b) are connected to the platform (11) via a supporting structure (13).

4. The device (10) according to claim 3, characterized in that the supporting structure (13) comprises two U-shaped supporting tubes (14a, 14b) with in each case one straight tube section (14a′, 14b′) and two end sections (14a″, 14b″) which are bent away in each case from the straight tube section (14a′, 14b′), the end sections (14a″, 14b″) preferably being connected in each case to the platform (11).

5. The device (10) according to claim 4, characterized in that the U-shaped supporting tubes (14a, 14b) are connected to one another by way of one, two, three or more than three transverse connections, the transverse connections preferably being tubes which extend substantially orthogonally with respect to the straight tube sections (14a′, 14b′) of the supporting tubes (14a, 14b).

6. The device (10) according to claim 4, characterized in that the handles (12a, 12b) are arranged on the straight tube sections (14a′, 14b′) and can be displaced along the straight tube sections (14a′, 14b′).

7. The device (10) according to claim 1, characterized in that the handles (12a, 12b) extend substantially orthogonally with respect to the straight tube sections (14a′, 14b′) of the supporting tubes (14a, 14b).

8. The device (10) according to claim 3, characterized in that a seat (15) is arranged on the supporting structure (13).

9. The device (10) according to claim 8, characterized in that the seat (15) is arranged on the straight tube sections (14a) of the supporting tubes.

10. The device (10) according to claim 8, characterized in that the seat (15) is arranged between the handles (12a, 12b).

11. The device (10) according to claim 8, characterized in that the seat (15) has a substantially identical or greater horizontal extent to/than the platform (11).

12. The device (10) according to claim 1, characterized by a control unit which is set up to control the first actuator.

13. The device (10) according to claim 12, characterized in that the control unit is set up to vary the intensity, the speed and/or the extent of the vibration movement (V).

14. The device (10) according to claim 1, characterized in that the platform (11) has a stepping area (16) which is set up to be stepped on by a device user.

15. The device (10) according to claim 1, characterized by a plurality of feet (40a-40d) which are connected to the main body (G), it being possible for the height of one, a plurality or all of the feet (40a-40d) to be set.

16. The device (10) according to claim 3, characterized in that the supporting structure (13) is connected releasably to the platform (11).

17. The device (10) according to claim 3, characterized in that the platform comprises a plurality of, preferably four, receptacles for releasable fastening of the supporting structure (13), via which receptacles the supporting structure can be connected releasably to the platform (11).
